(19) United States
(12) Patent Application Publication
(10) Pub. No.: US 2011/0316304 A1
(43) Pub. Date: Dec. 29, 2011

(54) ANTITRAP PROTECTION SYSTEM FOR MOVING SYSTEM

(76) Inventors: Hans Schwaiger, Muenchen (DE); Thomas Kandziora, Schwabhausen (DE); Peter Fasshauer, Neubiberg (DE); Claus Kaltner, Bergkirchen (DE)

(21) Appl. No.: 12/527,563

(22) PCT Filed: Jun. 18, 2009
(86) PCT No.: PCT/EP09/57643

§ 371 Date: Sep. 9, 2009

(30) Foreign Application Priority Data
Jun. 18, 2008 (DE) 102008028932.9

(51) Int. Cl. B60J 7/00; H02P 3/00

(52) U.S. Cl. 296/107.01; 318/478

(57) ABSTRACT

The invention provides an antitrap protection system for a moving system. The antitrap protection system comprises
a capacitor system, with a first electrode device, which comprises a first and a second electrode, and a second electrode device, which comprises a third and a fourth electrode;
an LC oscillating circuit formed by the first electrode device and an inductance;
a signal generator for charging the first electrode device and the second electrode device with an adjustable frequency and amplitude; and
a capacitor for coupling the signal generator with the first electrode device and the second electrode device;
   whereby the signal provided by the signal generator and the signal present at the LC oscillating circuit form a first indication for an approach of an object to the electric field of the first electrode device, and the signal provided by the signal generator and the signal tapped at the fourth electrode form a second indication for an approach of an object to the electric field of the second electrode device.

### FIELD OF THE INVENTION

The invention relates to an antitrap protection system for a moving system, especially for a convertible top system for vehicles. The invention moreover relates to a moving system with at least one moving component, one further component and an antitrap protection system according to the invention. Moreover the invention relates to a vehicle, especially an automobile with an electrically actuated convertible top system and with an antitrap protection system according to the invention.

### STATE OF THE ART

In electrically, hydraulically or power-operated moving components in a moving system, like for example in convertible top systems in vehicles, there is, during the closing process and/or during the opening process of the moving system or the moving components, basically the danger of body parts getting caught, by which in some cases persons can be injured seriously. In the course of a more and more diffused application of electrically, hydraulically or power-operated sliding roofs or convertible tops, an early and safe detection of an entrapment situation is increasingly important, since the motion sequence of such convertible top systems for automobiles is frequently automatized and not monitored by an operator.

For example convertible motor vehicles frequently present a movable convertible top, which can be moved for example by key actuation semiautomatically or automatically from an open into a closed position or vice versa. The closing process of the convertible top can be caused however also by a sensor, for example a rain sensor, fully automatically. The convertible top motion usually takes place by a hydraulic drive, which drives a convertible top mechanism, that comprises the single movable components of a convertible top system. Moreover also tailgates or trunk lids can be moved electrically, hydraulically or power-operated, i.e. be opened and/or closed.

Known sensor systems for detection of a potential entrapment situation do not offer a sufficient antitrap protection. For example it is known to implement for example an electrical sliding roof with pressure sensors, which on closing by means of the pressure against these pressure sensors are to is recognize an entrapment situation. The use of pressure sensors however presents the serious disadvantage that a pressure against soft objects, for example a child's hand, is often insufficient for recognizing an entrapment situation with sufficient precision. Not recognizing such an entrapment situation may cause injury.

Further known sensor systems use the load of the driving component, which drives the movable parts of a convertible top system, in order to detect an entrapment situation. Exceeding a determined load of the driving component can be evaluated by the system as pressure against the closing component. The measurement can be direct or indirect, for example an rpm measurement.

The mentioned known sensor systems for detecting entrapment situations in moving systems moreover present the disadvantage that the movable or the closing component must first get into contact with the object which is in the moving area of the moving system in order to allow a detection of an entrapment situation in the first place. Another disadvantage of this systems is that first a determined pressure against the object situated in the range of motion of the moving system must be exceeded in order to recognize the object at all. Accordingly soft objects are not recognized or not early enough. Especially in the known systems a mechanical run-on of the movable components after recognizing the entrapment situation can entail that for example a closing process is for the moment continued before it is interrupted.

Further known sensor systems are based on an optic detection of the object situated in a range of motion of a moving system. For example it is known to provide infra-red sensor systems in lifts, with which a person situated between the movable lift doors is to be recognized. Such systems have the disadvantage that only a defined area of the range of motion of the lift doors can be supervised. A prevention of an entrapment in a not supervised area, for example in the lower area of the lift door, is usually not possible. Moreover infra-red sensor systems present the disadvantage that they are used only for monitoring a delimited area, since an extensive monitoring, like for example over the total height of lift doors, is complex and expensive.

### OBJECT OF THE INVENTION

The object of the present invention is to avoid the known disadvantages at least partially and to provide an antitrap protection system which can also be used in case of small available clearance and which reliably and possibly early detects an intrusion into the range of motion of electrically, hydraulically or power-operated components of a moving system, especially of a convertible top system of a vehicle, and above also makes possible monitoring the whole range of motion.

### SOLUTION ACCORDING TO THE INVENTION

According to the invention this task is solved with an antitrap protection system for a moving system, a moving system with an antitrap protection system and a vehicle with a convertible top system and an antitrap protection system according to the characteristics of the independent claims.

Thus, an antitrap protection system for a moving system is provided, comprising an LC oscillating circuit, which comprises an electrode device with a first electrode and a second electrode and an inductance, the electrode device being part of a capacitor system; further comprising a signal generator to operate the LC oscillating circuit with an adjustable frequency and amplitude; further comprising a capacitor for coupling the signal generator with the LC oscillating circuit. The signal provided by the signal generator and the signal present at the LC oscillating circuit is indicative for an approach of an object to the electric field of the electrode device.

The antitrap protection system may further comprise a XOR gate for connecting the signal provided by the signal generator with the signal applied to the LC oscillating circuit, whereby the signal provided by the signal generator and the signal present at the LC oscillating circuit are fed to the XOR gate over a comparator for producing a square signal and whereby the signal present at the XOR gate exit is indicative for an approach of an object to the electric field of the electrode device.

It has proven advantageous to use a steady component (or direct component) as indicator for an approach. The steady component, preferably a steady component which is less than a predetermined value, of the signal present at the XOR gate exit may be indicative for an approach of an object to the electric field of the electrode device.

The signal present at the XOR gate exit may be fed to a low pass filter, and the signal emitted by the low pass filter or the steady component, preferably a steady component which is less than a predetermined value, of the signal emitted by the low pass may be indicative for an intrusion into the electric field of the electrode device.

A change of the capacity of the electrode device causes a phase shift between the signal provided by the signal generator and the signal present at the LC oscillating circuit, which is indicative for an approach of an object to the electric field of the electrode device.

Preferably the signal generator may be adjustable in the generator frequency and/or the generator voltage, whereby the inductance may be formed as a passive inductance or active inductance, preferably as a Gyrator.

Particularly preferably the adjustable frequency is situated in the range of the parallel resonance frequency of the LC oscillating circuit, and a change of the electric field or the capacity of the electrode device conditioned by a motion of the moving system may be compensated. Movements of the moving system determined by the system in this way are not recognized as intrusion into the electric field. A compensation can take place is by readjusting the signal generator on the resonance frequency of the LC oscillating circuit.

The antitrap protection system may be connectable to an evaluating device.

Preferably the quality factor of the LC oscillating circuit may be adjustable by a current input proportional to the oscillation circuit voltage.

Moreover an antitrap protection system for a moving system is provided, comprising an electrode device with at least one first electrode and at least one second electrode, which is part of a capacitor system, and a signal generator for operating the capacitor system with an adjustable frequency and amplitude, whereby the signal generator is coupled with the first electrode of the electrode device, whereby the signal provided by the signal generator and the signal tapped at the second electrode of the electrode device are indicative for an approach of an object to the electric field of the electrode device.

The antitrap protection system may comprise an amplifier, whereby the signal used at the second electrode of the electrode device is fed to this amplifier, whereby the signal provided by the signal generator is used by means of a first phase-shifter and a switch for detection of the signal present at the exit of this amplifier, and whereby the detected signal is indicative for an approach of an object to the electric field of the electrode device. The amplifier can be a transimpedance amplifier, preferably with bandpass feature. The detected signal is may be fed to a low pass filter, whereby the signal present at the exit of the low pass filter or its steady component is indicative for an approach of an object to the electric field of the electrode device.

Preferably the signal generator is adjustable as for the generator frequency and/or the generator voltage.

It is advantageous if a variation of the electric field of the electrode device conditioned by a motion of the moving system can be compensated. A compensation can take place by readjusting the signal generator voltage.

The antitrap protection system can be coupled with an evaluating device.

The antitrap protection system can have a countercurrent compensation arrangement, whereby the signal provided by the signal generator by means of the countercurrent compensation arrangement is coupled with the signal tapped at the second electrode. The countercurrent compensation arrangement can consist of an inverting amplifier and a second phase-shifter coupled with it.

Moreover a particularly advantageous antitrap protection system for a moving system is provided, comprising
at least one capacitor system, with a first electrode device, which comprises a first and a second electrode, and a second electrode device, which comprises a third and a fourth electrode;
a LC oscillating circuit formed by the first electrode is device and an inductance;
a signal generator for operating the first electrode device and the second electrode device with an adjustable frequency and amplitude; and
a capacitor for coupling the signal generator with the first electrode device and the second electrode device;
   whereby
the signal provided by the signal generator and the signal present at the LC oscillating circuit form a first indication for an approach of an object to the electric field of the first electrode device, and
the signal provided by the signal generator and the signal tapped at the fourth electrode form another indication for an approach of an object to the electric field of the second electrode device.

This particularly advantageous embodiment of an antitrap protection system is characterized by the fact that the indication methods of the aforementioned antitrap protection systems are combined in order to provide an even more effective and more exact antitrap protection system.

Advantageously the third electrode of the second electrode device is formed by the first electrode of the first electrode device.

The antitrap protection system may further comprise a XOR gate for connecting the signal provided by the signal generator with the signal present at the LC oscillating circuit, whereby the signal provided by the signal generator and the signal present at the LC oscillating circuit are fed to the XOR gate by means of a comparator for producing a square signal, and whereby the signal present at the XOR gate exit or a steady component, which is smaller than a predetermined value, constitutes the first indication of the signal present at the XOR gate exit.

The signal present at the XOR gate exit can be fed to a low pass, whereby the signal emitted from the low pass or the steady component, which is smaller than a predetermined value, constitutes the first indication of the signal emitted from the low pass.

The antitrap protection system may further comprise an amplifier, whereby the signal tapped at the fourth electrode is fed to this amplifier, whereby the signal provided by the signal generator by means of a first phase shifter and a switch is used for detection of the signal present at the exit of this amplifier and whereby the detected signal or its steady component constitutes the second indication. The amplifier can be a transimpedance amplifier, preferably with bandpass feature.

The detected signal can be fed to a low pass filter, whereby the signal present at the exit of the low pass filter or its steady component, which is smaller than a predetermined value, constitutes the second indication.

It is advantageous, when the signal generator is adjustable as for the generator frequency and/or the generator voltage.

The antitrap protection system can be coupled with an evaluating device.

The inductance can be formed as a passive inductance or active inductance, preferably as a Gyrator.

Preferably the antitrap protection system is formed in such a way that an intrusion into the range of motion of the moving system causes a variation of the first indication or the second indication. An intrusion into the range of motion of the moving system can also cause a variation of the first indication and the second indication.

There can also be a switch for coupling the signal generator with the first or third electrode.

Preferably the quality factor of the LC oscillating circuit is adjustable by a current input proportional to the oscillation circuit voltage.

The signal provided by the signal generator can be coupled by a countercurrent compensation arrangement with the signal tapped at the fourth electrode, whereby the countercurrent compensation arrangement comprises an inverting amplifier and a second phase shifter coupled with it.

The invention further provides a vehicle, especially an automobile, with an electrically actuated top system (sliding roof, convertible-top, trunk lid, etc.) and with an aforementioned antitrap protection system, especially with the last mentioned antitrap protection system, whereby the convertible top system comprises at least one moved component and whereby the antitrap protection system is formed in such a way that in the event of intrusion into the range of motion of the convertible top system, the closing process or the opening process of the convertible top system can be interrupted, stopped or reversed.

The first or third electrode of the last mentioned convertible top system can be formed by the moved component of the convertible top system, whereby the second electrode is formed by the vehicle body or chassis and whereby the fourth electrode is formed by at least one electrode arranged isolated on the vehicle in the outer area of the range of motion of the convertible top system.

It has been proved advantageous to arrange or design at least one electrode arranged isolated on the vehicle symmetrically to the longitudinal axis of the vehicle. In this way also the direction from which the intrusion comes can be detected.

Preferably the antitrap protection system is deactivatable in the closed and/or in the opened state of the convertible top system. Moreover the antitrap protection system can be also used as vandalism protection or theft protection.

The convertible top system can be connected to the vehicle body by means of a preferably switchable insulator.

The convertible top system can however also be decoupled electrically using a shield electrode of the vehicle body.

Further benefits and advantageous embodiments of the invention result from the description, the drawing and the claims.

### SHORT DESCRIPTION OF THE FIGURES

In the drawing, embodiments are illustrated in a schematically simplified way and in the following description explained more in detail.

The figures show:

FIG. 1 a first embodiment of an antitrap protection system according to the invention (Loading method);

FIG. 2 another embodiment of an antitrap protection system according to the invention (Absorption method);

FIG. 3 a third embodiment of an antitrap protection system according to the invention combining the antitrap protection systems shown in FIG. 1 and FIG. 2 (Loading/Absorption method);

FIG. 4 an advantageous embodiment of an electrode for the antitrap protection system according to the invention; and

FIG. 5 a top system with an antitrap protection system according to the invention in a car in the top view and in the side view.

### DETAILED DESCRIPTION OF THE INVENTION

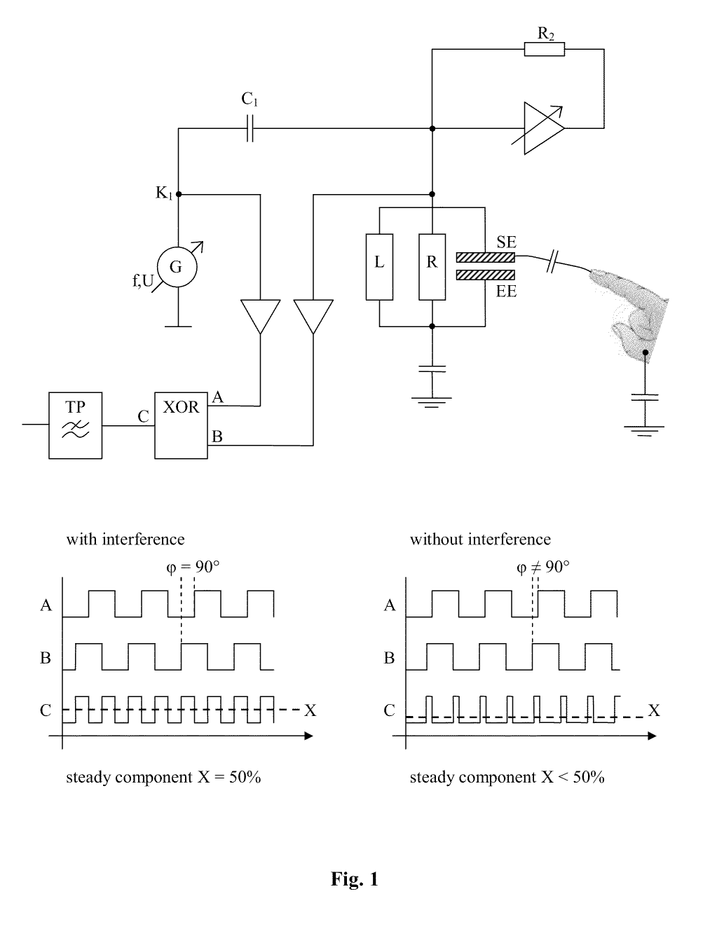

FIG. 1 shows a circuit diagram of a first advantageous embodiment of an antitrap protection system according to the invention. The operation of the antitrap protection system shown in FIG. 1 is indicated in the following as the so-called Loading method.

The antitrap protection system has an oscillation circuit, which is formed advantageously as LC parallel resonance circuit. The LC parallel resonance circuit consists of a coil L, a capacitor C formed by the electrodes SE and EE and the ohmic resistance R occurring in a real LC parallel resonance circuit. The electrode EE or is coupled with mass.

The inductance L can be designed both as a passive and as an active inductance, for example as a Gyrator.

A signal generator G, which is preferably adjustable as for the generator frequency and the generator voltage, generates a signal with a cycle of typically 100 . . . 120 kHz. Higher or lower frequencies are possible according to the concrete application of the antitrap protection system. By means of a second capacitor C1 the LC parallel resonance circuit is fed with the signal generated by the signal generator. At the same time also the electrode SE is fed with the signal of the signal generator (by means of the capacitor C1). Preferably the generator frequency F of the generator G is tuned to the resonance frequency of the LC parallel resonance circuit, which makes possible a particularly good sensitivity of the antitrap protection system as for an intrusion into a supervised area or a range of motion.

In operation at the electrode device, which comprises at least the electrodes SE and EE, or between the electrodes SE and EE, an electric field is generated, which corresponds to a determined capacity. If a part of the body approaches this electrode device, as in FIG. 1 schematically illustrated by a hand, the electric field between the electrodes SE and EE changes and thus also the total capacity of the LC parallel resonance circuit.

A change of the capacity of the LC parallel resonance circuit leads to a phase shift of the signal at the LC parallel resonance circuit as to the signal provided by the signal generator G.

The signal provided by the signal generator G (at K1) and the signal present at the LC parallel resonance circuit (at K2) can (in combination) serve as indication for an approach of an object to the electrode device (SE, EE). Advantageously in this respect the phasing of both signals is exploited, in that the phase shift of the signal at the LC parallel resonance circuit is determined as to the signal provided by the signal generator G.

The signal provided by the signal generator G (in the following indicated by SA) is tapped at the point K1, the signal present at the LC parallel resonance circuit (in the following indicated by SB) is tapped at the point K2. In normal operation, thus without an approach of an object to the electrode device (SE, EE) the phase shift of the signal SB in the resonance point as to the signal SA amounts to 90°.

Both signals SA and SB are fed to a comparator or two comparators in order to generate from the sinusoidal signals two square signals.

The square signals are fed to a gate, preferably a XOR gate or a gate-combination with XOR functionality. The signals at the entries A and B of the XOR gate (in the normal operation in the resonance point dephased by 90°) are illustrated in the chart “without intrusion” in FIG. 1 over time.

By means of the XOR function of the XOR gate, at its exit C a signal (in the following indicated by SC) with a frequency equal to the double of the resonance frequency of the LC parallel resonance circuit is provided.

In this respect it is particularly important that the pulse width of the signal SC depends on the phase shift or is directly proportional to the phase shift of the signal SB compared to signal SA. The signal SC provided by the XOR gate can thus also serve as an indication for an approach of an object to the electrode device (SE, EE). In normal operation the pulse width of the signal SC corresponds to half the pulse width of signal SA or SB. The signal SC present at exit C is illustrated also in the chart “without intrusion” in FIG. 1 over time.

The phase shift unequal to 90°, resulting because of an approach of an object to the electrode device (SE, EE), of the signal SB compared to signal SA and the resulting (by means of XOR operation) signal SC with a pulse width different from SA or SB are illustrated in the chart “with intrusion” in FIG. 1 over time.

The signal SC present at the exit C of the XOR gate is fed to a low pass filter TP. The signal emitted by this low pass filter TP represents the steady component of the signal present at the low pass entry SC. This steady component can thus also serve as indication for an approach of an object to the electrode device (SE, EE).

Depending on the concrete application field, for the normal operation, i.e. in the operation without intrusion in the range of motion, a predetermined value of the steady component is determined, which is characteristic for the normal operation.

In the embodiment shown here according to FIG. 1 the steady component in normal operation amounts to almost 50%, particularly preferably exactly 50%.

A steady component of almost 50% serves thus as an indication for the fact, that no object has approached the electrode device (SE, EE) or is near the electrode device.

If an object approaches the electrode device (SE, EE), then, conditioned by the phase shift of the signal SB as to the signal SA, the pulse width of the XORed signal SC diminishes (cf. chart with intrusion in FIG. 1), which corresponds to a diminution of the steady component of the signal present at the this low pass filter exit. A steady component of less than 50% serves in this embodiment as indication for the fact that an object approaches the electrode device (SE, EE).

In the charts “without intrusion” and “with intrusion” the steady component is each time indicated by X. In another embodiment for the steady component an area (e.g. [45% . . . 50%]) can be defined, inside which a change or diminution of the steady component is not to be detected as an approach of an object to the electrode device. In this way for example the sensibility of the antitrap protection system can be adjusted.

The signal present at the exit of the low pass filter TP can be fed to an evaluating device (not represented here). The evaluating device can then for example process the received signal, for example carry out a compensation of the signal. A compensation of the signal can be necessary for example if environmental technique influence or the ageing of the antitrap protection system must be considered. Additionally the evaluating device can be coupled for example with a servomotor of a moving system, in order to stop in this way a closing component in the case in which an intrusion into the electrode device (SE, EE) was detected (i.e. when the steady component is smaller than a predestinated value) or to annul the closing process.

In the embodiment shown here the signal generator G provided a sinusoidal wave signal. The antitrap protection system according to the invention can be run however also with a signal generator which provides a square signal. In this case the comparator at the entrance A of the XOR gate can be dispensed with. In this respect additional EMC relevant conditions have to be observed.

The antitrap protection system according to the invention according to the embodiment shown in FIG. 1 can be used as antitrap protection system in vehicles.

In one form the system can be used for monitoring the range of motion of the movable components of a top system, for example a convertible roof. In doing so the electrode SE of the antitrap protection system according to FIG. 1 is coupled with the movable part (or with the electric conductive parts) of the convertible top system. The movable part of the convertible top system thus constitutes the electrode SE of the antitrap protection system.

The electrode EE is coupled with the vehicle frame, the chassis, or the vehicle body. Vehicle frame, chassis, and vehicle body each present a strong coupling to earth. Vehicle frame, chassis, or vehicle body form the electrode EE of the antitrap protection system.

The movable part of the top system and the vehicle frame must not be electrically coupled with each other, that means, they must be mutually isolated. Especially the movable part of the convertible top system should not also be coupled with mass. In certain cases however a coupling against mass of the movable part is necessary or prescribed, for example in case of a tailgate on which several electric consumers can be arranged (e.g. taillights).

In case of an electrically lockable tailgate, the electrode SE can be formed by the tailgate, in order to detect in this way an intrusion into the range of motion of the closing tailgate using the antitrap protection system according to the invention.

In order to nevertheless allow the operation of the antitrap protection system according to the invention, it is proposed to decouple from mass the tailgate normally coupled with mass during the operation of the antitrap protection system (thus during the closing process of the tailgate). For this purpose at those points at which the tailgate is connected with mass, a switchable insulator can be provided, which isolates only during the closing process. The tailgate can be decoupled electrically also using a shield electrode of the vehicle body.

On closing the top or the tailgate, because of changed distances the electric field between the top or the tailgate and the vehicle body changes, which corresponds to a change of the electric field between the electrode SE and the electrode EE or a change of the capacity of the condenser C formed by the electrodes SE and EE.

In order not to interpret such changes of the electric field conditioned by the adjusting process as an indication for an intrusion in the range of motion of the movable components, since on closing because of the capacitance changement also the steady component (or the phase shift) changes, arrangements are provided, which hide or compensate the changes conditioned by the adjusting process.

A compensation can happen for example by readjusting the signal generator G, so that it is always on the resonance frequency of the LC parallel resonance circuit.

An intrusion into the electric field of the electrodes SE and EE causes a particularly strong capacitance changement over a short time (high speed of the capacitance change), which has as a consequence an abrupt reduction of the steady component. This effect is exploited for the readjustment of the signal generator G.

Moreover a compensation can take place on the basis of a trajectory, which for example indicates the steady component depending on the position of the top as to the vehicle body. This compensation can be done for example by the evaluating device, by comparing the current value present at the exit of the low pass TP with a desired value, which depends on the position of the top. A deviation from the desired value can be interpreted as indication for an intrusion into the range of motion of the movable component. For the deviation from the desired value a determined interval can be provided (e.g. ±5%), within which a deviation is not to be interpreted as intrusion.

Additionally in the compensation also the moving speed of the top and/or the speed of the change of the steady component or the deviation from a desired value can be measured and included in the compensation process. In this way also variations of the trajectory which cannot be attributed to an intrusion in the range of motion can be adjusted. For example the present course of the steady component depending on the position of the top on a parking lot can be different from the present course in a parking garage. Equally the present course of the steady component can vary in case of a moving automobile.

Eventually a compensation can be done also by means of a quality factor control of the LC parallel resonance circuit. This can be done by a current input proportional to the oscillation circuit voltage. This can be realized by means of an adjustable amplifier V and a series resistance R2 situated between LC oscillating circuit and amplifier exit, by which a fed back system results.

Especially the antitrap protection system proposed in FIG. 1 is particularly insensitive to disturbances, since both the LC parallel resonance circuit because of its bandpass property and the low pass filter connected to the XOR exit filter out disturbers as far as possible.

If the moving system to be supervised has several moved components, all the moved components can be used as an electrode SE. At the same time it is sufficient to provide only one electrode EE. For example the top and the tailgate of a vehicle each can form an electrode SE, and the vehicle body can form the electrode EE. In order to avoid reciprocal influences of the electrodes SE formed by the movable components, it is advantageous to charge the single movable components with a different generator frequency.

Alternatively also a switch can be provided in order to switch over between the single electrodes SE or to activate each time only one electrode SE. The switch can be realized by a multiplexer.

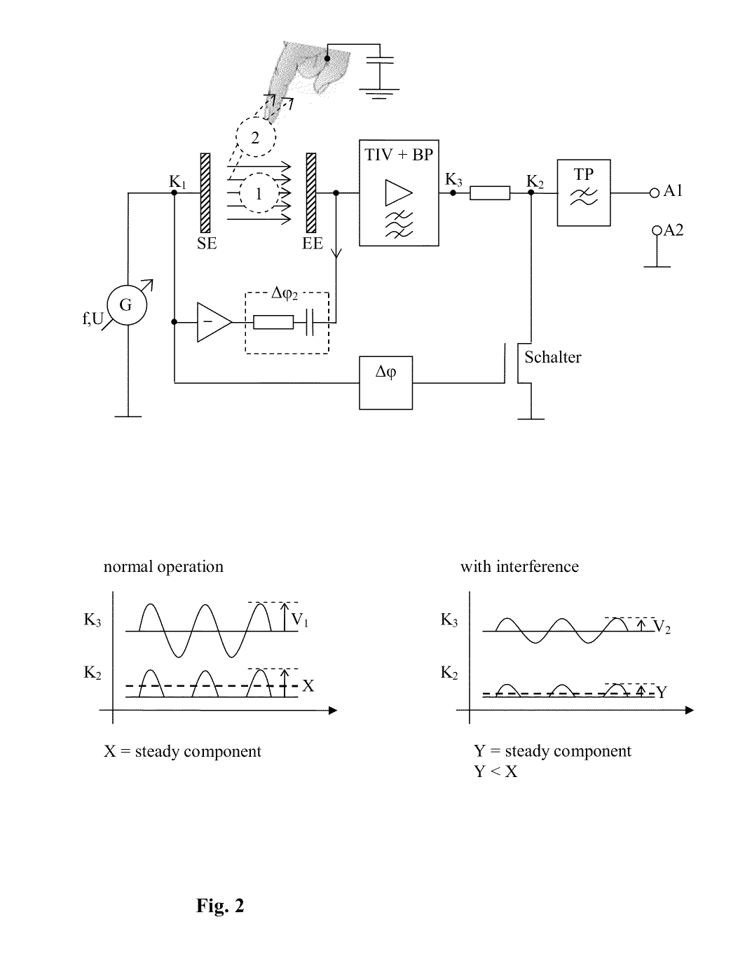

FIG. 2 shows a circuit diagram of a second embodiment of an antitrap protection system according to the invention. The operation of the antitrap protection system shown in FIG. 2 is indicated in the following as the so-called absorption method.

An electrode system formed by an electrode SE and an electrode EE, in which the electrodes SE and EE form a capacitor, is fed with a signal of a determined frequency. The electrode SE is coupled with the signal generator G. The signal is provided by the signal generator G, which preferably is adjustable in its frequency F and its generator voltage U.

In operation between the electrodes SE and EE an electric field 1 is generated, in which the capacitor formed by the electrodes SE and EE has a determined capacity.

The signal present at the exit of the electrode EE is fed to an amplifier with filter, preferably a transimpedance amplifier with bandpass filter (TIV+BP).

The signal present at the exit of the transimpedance amplifier with bandpass filter is coupled with a signal tapped at the signal generator G, in which the tapped signal is fed first to a phase shifter Δφ. The phase shifter Δφ has the task of adapting the phase of the generator signal (at K1) to the phase of the signal present at the exit of the transimpedance amplifier (at K2), in order to compensate the phase shift of the generator signal caused by the electrodes SE and EE as well as by the transimpedance amplifier. The signal present at the exit of the transimpedance amplifier then has the same phase as that at the exit of the phase shifter Δφ.

The signal present at the phase shifter exit has the task to switch the following switch.

This switch can be a transistor. This switch serves as synchronous demodulator, which is switched in the cycle of the signal generator G against mass, so that each time the signal present at the exit of the transimpedance amplifier is only fed to the following low pass filter TP when the switch is not switched against mass. Which part of the signal present at the exit of the transimpedance amplifier is fed to the low pass filter TP, depends on the phase shift of the signal provided by the phase shifter Δφ compared to the signal at the point K2. In a phase shift of φ=0 thus only the positive half wave of the signal present at the exit of the transimpedance amplifier is fed to the following low pass filter TP.

By the synchronous demodulation at the same time also parasitic signals can be suppressed or compensated effectively.

The signal modulated in this way (signal at the point K2) is then fed to a low pass filter TP, at the exit (A1, A2) of which then there is DC voltage. The signal at the exit A1, A2 serves as an indication for a change of the electric field between the electrodes SE and EE.

The diagrams in FIG. 1 show the signals at K3, K2 and at the exit A1 each in normal operation (without intrusion into the electric field) as well as in case of intrusion into the electric field. The phase shifter Δφ is set in such a way that the phase shift φ of the signal provided at the exit of the phase shifter Δφ as to the signal at K3 preferably amounts to 0°.

In normal operation K3 has a sinusoidal signal with an amplitude V1. By the modulation of the signal with the help of the switch, at the point K2 arises a sinusoidal signal, which comprises only the positive half wave of the original signal at K3. With the low pass filter TP at the exit A1 a DC voltage with voltage U is provided. The steady component of the signal at exit A1 is indicated by X in the chart for the normal operation.

An intrusion into the electric field of the electrode device entails that a part of the electric field is absorbed and the amplitude V1 of the original signal at point K3 diminishes down to the amplitude V2. At the point K2 there is a sinusoidal signal with only positive half waves with the amplitude V2. The DC voltage generated by the low pass TP has then a voltage U2, which is smaller than the original voltage U in normal operation. A reduction of the voltage of the DC voltage present at exit A1 serves as indication for an intrusion into the electric field of the electrode device. The steady component of the signal present at exit A1 is indicated by Y in the chart for the intrusion.

The antitrap protection system shown in FIG. 2 moreover has a countercurrent compensation. The signal provided by the signal generator G is coupled by means of a countercurrent compensation arrangement, which is formed by an adjustable inverting amplifier and a second phase shifter Δφ2, with the signal tapped at the electrode EE. The second phase shifter can be formed for example by a capacitor and a series resistance situated between capacitor and inverting amplifier. The second phase shifter Δφ2 is necessary, since the signal tapped at the electrode EE does not necessarily comprise the same phase shift as to the generator signal as the signal at K3.

The antitrap protection system according to the invention according to the embodiment shown in FIG. 2 can be used as antitrap protection system in vehicles.

In one form the antitrap protection system can be used for monitoring the range of motion of the movable components of a convertible top system, for example a convertible roof. Here the electrode SE of the antitrap protection system according to FIG. 2 is coupled with the movable part (or with the electrically conductive parts) of the convertible top system. The movable part of the convertible top system thus constitutes the electrode SE of the antitrap protection system.

The electrode EE can be arranged at suitable places, for example in the upper area of the A-pillars or at the body component group connecting the A-pillars, the disposition being such that there is no electric coupling with the vehicle frame, the chassis or the vehicle body or against mass.

The movable part of the top system (=electrode SE) and the electrode EE thus jointly form an electrode device according to the antitrap protection system shown in FIG. 2.

In operation on the electrode device or between the movable part of the convertible top system and the electrode EE an electric field forms, with which the range of motion of the movable part of the convertible top system can be supervised. An intrusion into this range of motion leads to a change of this electric field or the capacity of the condenser system formed by the electrode EE and the movable part of the convertible top system.

By the configuration according to the invention of the circuit of the antitrap protection system, at the exit A1 an equisignal is provided, which is indicative for an intrusion in this range of motion.

The output signal of the antitrap protection system according to FIG. 2 can be fed to an evaluating device. The evaluating device can for example command the servomotor for the convertible top system, and in the event of intrusion (which corresponds to a reduction of the voltage at A1) interrupt or annul the moving process.

In order to detect changes of the electric field conditioned by the adjusting process not as intrusion into the electric field of the electrode device, the antitrap protection system can be formed in such a way that such changes can be compensated.

In a first variant the compensation can happen for example by readjusting the signal generator G as for its generator voltage U, so that the signal present at the electrode EE always has the same amplitude, independent from a change or not of the electric field of the electrode device.

Since the antitrap protection system according to the invention has a high sensitivity, i.e. an intrusion into the electric field of the electrode device particularly strongly influences on the amplitude variation over time, an adjustment of the generator voltage can take place without adjusting and thus not detecting a change of the electric field on the electrode device caused by an intrusion.

Moreover a compensation can take place on the basis of a trajectory, the trajectory for example indicating the voltage at the exit A1 depending on the position of the top as to the electrode EE. This compensation can be done for example by the evaluating device, by comparing the current value present at the exit A1 with a desired value, which depends on the position of the top. A deviation from the desired value can be interpreted as indication for an intrusion into the range of motion of the movable component.

Alternatively or additionally in case of the compensation also the moving speed of the top and/or the speed of the change of the voltage at the exit A1 or the deviation from a desired value can be measured and included in the compensation process.

In this way also variations of the trajectory which cannot be attributed to an intrusion in the range of motion can be adjusted.

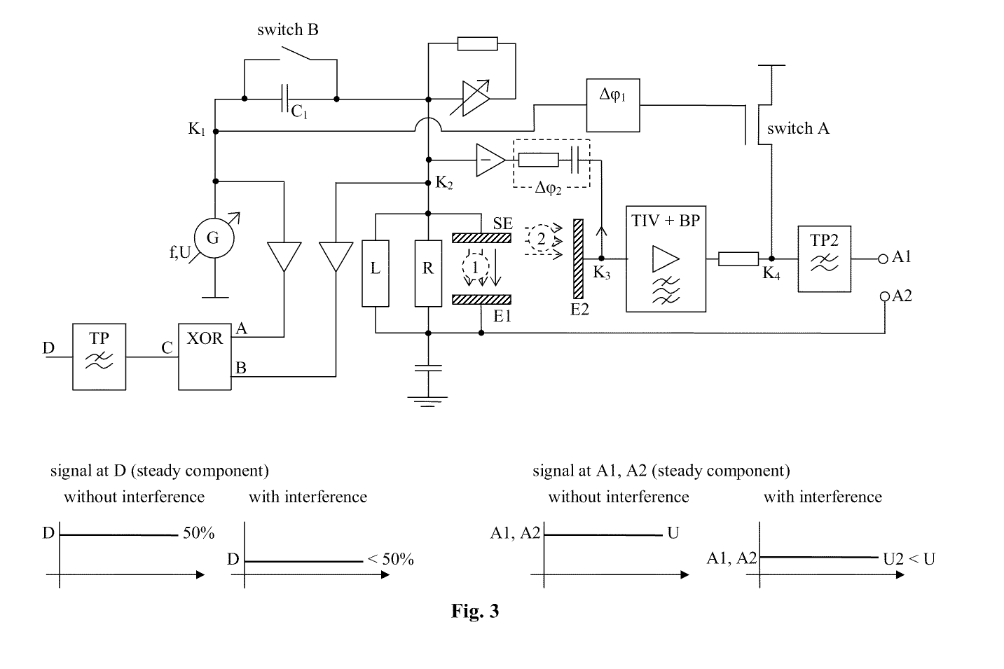

Special embodiments of the electrode(s) EE are described below in connection with the embodiment of an antitrap protection system shown in FIG. 3.

Several electrodes SE can be provided. This can be reached for example by segmenting an electrode SE. Single electrodes of the several electrodes can be activated by a switch (e.g. a multiplexer) individually.

FIG. 3 shows a circuit diagram of a third embodiment of an antitrap protection system according to the invention. The operation of the antitrap protection system shown in FIG. 3 is indicated in the following as the so-called loading/absorption method.

Substantially the loading/absorption method is based on a combination of the loading method (cf. FIG. 1) with the absorption method (cf. FIG. 2). The special advantage of the combination of both these methods consists in the fact that two different methods based on the same principle are used for monitoring the range of motion, which guarantees an even safer and more effective antitrap protection.

The structure of the antitrap protection system shown in the circuit diagram in FIG. 3 substantially corresponds to the structure (or the combination) of the antitrap protection systems shown in FIG. 1 and FIG. 2.

Both systems are operated by a common signal generator G, which is adjustable as for the generator frequency F and the generator voltage U. The signal provided by the signal generator G is fed to a phase shifter Δφ1 and serves for switching the following switch A. At the same time by means of a capacity the LC oscillating circuit is fed with the signal provided by the signal generator G.

The electrode device as for the Loading method is formed by the electrodes SE and E1. The electrode device as for the absorption method is formed by the electrodes SE and E2. The electrode SE serves at the same time as transmission electrode for the loading method and for the absorption method, which makes possible a particularly advantageous structure of the antitrap protection system according to the invention.

In operation at both electrode devices or between the electrodes SE and E1 and between the electrodes SE and E2 an electric field 1 or an electric field 2 forms. The electrode arrangement, for example on a vehicle with a convertible top device, preferably is selected in such a way that in case of an intrusion in the range of motion of the convertible top device at least one of the two electric fields varies, in order to be able to detect the intrusion. It is particularly preferred that the electrode arrangement is selected in such a way that the electric fields of both electrode devices vary.

The signal present at the point K2 is, as described above for FIG. 1, dephased by 90° as to the signal provided by the signal generator (at K1). The signals tapped at K1 and K2 are fed to a XOR gate by means of each time a comparator, the result of which is fed to a following low pass filter TP. The signal provided by the low pass filter TP, which indicates the steady component of the signal fed to the low pass filter TP, serves as an indication for an intrusion into the electric field of the electrode device SE, E1 (cf above, description for FIG. 1). Thus the phase shift between the signals tapped at K1 and K2 or the resonance performance is exploited in order to detect an intrusion.

The signal dephased by 90° at K2 is also used to generate the electric field between the electrodes SE and E2. Thus also the signal present at K3 is dephased by 90° as to the generator signal in the resonance point.

In order to allow the synchronous demodulation described above for FIG. 2, the signal tapped at K1 is dephased by 90° with the phase shifter Δφ1, so that the switch A in the cycle of the signal generator switches the signal present at K4 against mass. This will allow that, also in combination with the loading method, to the low pass filter TP2 are fed only the positive half waves of the signal present at K3.

At the exit of the low pass filter TP2 thus a DC voltage is available, which serves as indication for an intrusion into the electrode device SE, E2 (cf. above, description of FIG. 2). Thus the amplitude variation of the signal present at exit A1 is exploited in order to detect an intrusion.

The signal present at K4, conditioned by the transimpedance amplifier with bandpass-property (TIV+BP), can also have a phase shift of unequal 90° as to the generator signal. In this case the phase shifter Δφ1 is to be designed in such a way that the signal provided by the phase shifter Δφ1 is in phase with the signal present at K4.

Additionally a switch B can be provided in order to bridge the capacity by which the signal generator is coupled with the electrode SE, in order to prevent in this way a breakdown of the voltage at the circuit arrangement for the absorption process. The switch B can be coupled for example with a microcontroller, in order to allow for example a cyclic switching of switch B or a switching of switch B if necessary.

Additionally a countercurrent compensation arrangement is provided, which is formed as described in FIG. 2.

Also in this particularly advantageous embodiment of the antitrap protection system according to the invention it is necessary to compensate changes conditioned by the adjusting process of the electric fields at the electrode devices, which occur for example on closing a convertible top system of an automobile, so that such changes are not recognized by mistake as an intrusion into the range of motion of the convertible top system.

For this purpose the methods already described above for FIG. 1 and FIG. 2 can be used.

A change of the phase shift of the signal tapped at K2 as to the signal tapped at K1, conditioned by the adjusting process, can take place for example by adjusting the generator frequency F, so that the latter is always on resonance frequency of the LC parallel resonance circuit. A change of the amplitude of the signal present at K3 conditioned by the adjusting process can take place for example by adjustment of the generator voltage U.

The further methods described above for FIG. 1 and FIG. 2 can be also used both alternatively or in combination with the adjustment of the signal generator. Especially the quality adjustment described in FIG. 1 can be also used.

The antitrap protection system shown in FIG. 3 can be coupled with an evaluation unit, which, depending on the signals present at the exits D or A1, commands an adjusting device, for example for a convertible top system for vehicles. The evaluating device can consider additional parameters. Typically let us name here parameters which consider temperature conditioned variations of single components of the antitrap protection system based on their temperature dependence. Variations resulting from this at the output signals of the antitrap protection system can be compensated or corrected by the evaluating device.

The antitrap protection system according to the invention according to the embodiment shown in FIG. 3 can be used as antitrap protection system for vehicles.

In one form the system can be used for monitoring the range of motion of the movable components of a convertible top system, for example a convertible roof. Here the electrode SE of the antitrap protection system according to FIG. 3 is electrically coupled with the movable part (or with the electrically conductive parts) of the convertible top system. The electrode SE according to FIG. 3 is formed in such a way by the movable part of the convertible top system.

The electrode E2 can be arranged at suitable places, for example in the upper area of the A-pillars or in the body component group connecting the A-pillars, the disposition being selected in such a way that there is no electric coupling with the vehicle frame, the chassis or the vehicle body or against mass. The movable part of the convertible top system (=electrode SE) and the electrode E2 so jointly form the electrode device SE-E2 according to the antitrap protection system shown in FIG. 3, on which in operation the electric field 2 forms.

The electrode E1 is electrically coupled with the vehicle frame, the chassis, or the vehicle body. Vehicle frame, chassis and vehicle body each have a good coupling to earth. Vehicle frame, chassis or vehicle body form the electrode E1 of the antitrap protection system. The movable part of the convertible top system (=electrode SE) and the chassis (=electrode E1) so jointly form the electrode device SE-E1 according to the antitrap protection system shown in FIG. 3, on which in operation the electric field 1 forms.

In order to guarantee a correct way of functioning of the antitrap protection system, the movable part of the convertible top system (=electrode SE) and the vehicle frame (=electrode E1) must not be electrically coupled with each other, that means, they must be isolated from each other. A separation of the normally coupled parts can take place as described above for FIG. 1 e.g. with the help of a switchable insulator. In this way the movable part of the convertible top system can always be decoupled from mass when a closing or opening process of the top system takes place.

In order to allow a good detection of an intrusion into the range of motion by the absorption switching according to FIG. 3 and FIG. 2, the form of the electrode E2 (or the electrode EE in FIG. 2) is particularly important. In this respect it is advantageous to design the electrode E2 in such a way that its active area is possibly small in relation to the object penetrating into the range of motion (for example a hand). The smaller the active area is, so much the better is the detection, since the changes of the electric field or of the capacity of the condenser formed by the electrodes SE and E2 are greater.

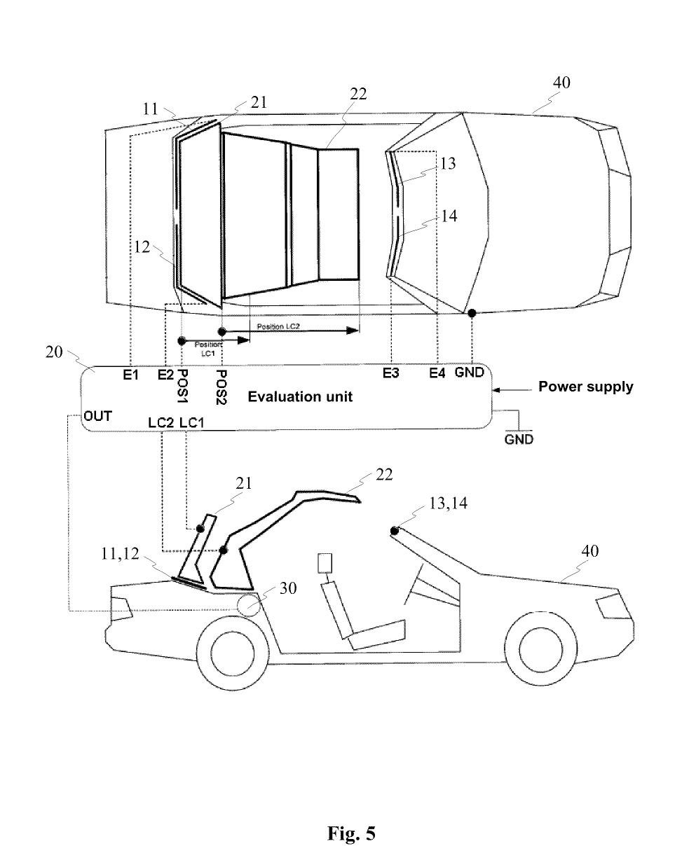

Therefore it can be necessary under particular conditions to provide several electrodes E2 (so-called segmentation), in order to be able to survey a range of motion completely. This will ensure that with increasing size of the areas to be supervised the quality of the detection does not decrease. A special disposition of several electrodes E2 is shown in FIG. 5.

There the electrodes 11, 12 or 13, 14 (=electrodes E2) are arranged symmetrically to the vehicle longitudinal axis.

With a switch (for example a multiplexer) it is possible to is activate always exactly one of the several electrodes E2. The switch is arranged preferably between the electrodes E2 and the transimpedance amplifier (TIV+BP). At the exit A1 then there is each time the signal for the active switched electrode E2.

The symmetric disposition of the electrodes E2 has several benefits:

1.) In addition to the intrusion into the range of motion also the direction from which the intrusion comes can be detected. This is possible thanks to the fact that the signal at A1, for that electrode at which the approach takes place, varies more than the signal at A1 or that of the other electrode(s). A (roughly) equal change of the output signals at A1 suggests that the approach or the intrusion into the range of motion takes place roughly in the center.

2.) For the compensation process described above for compensation changes conditioned by the adjusting process, which carry out a compensation based on the position of the top as to the vehicle body, the determination of the position of the top can be dispensed with, since based on the symmetry of the electrodes the changes of the corresponding output signals proceed roughly equally, so that based on the difference of the changes between two electrodes independently of a compensation an intrusion in the range of motion can be detected based on the position. Additional sensors for determining the position of the top can so be dispensed with.

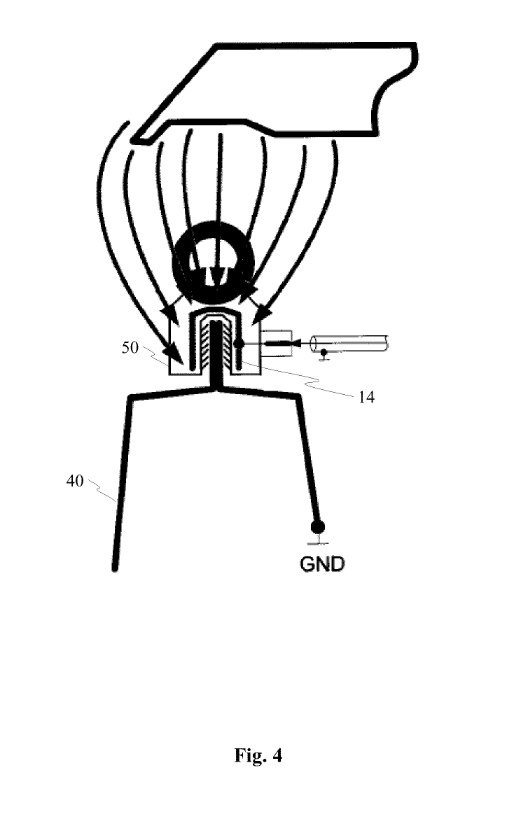

It is particularly advantageous to use means already present on a vehicle as electrodes E2. For example, as shown in FIG. 4, the retaining clamps that fix a sealing rubber at the body can be used.

Especially the method according to FIG. 3 can be run also using two electrodes SE, in which a first electrode SE1 is used for the loading method and another electrode SE2 for the absorption method.

FIG. 4 shows the disposition of a retaining clamp in a sealing rubber 50 on the body 40, which can be used as electrode E2 (reference sign 14). Many sealing rubbers present an integrated metallic retaining clamp for stably fixing the sealing rubber on the body. This retaining clamp can be used as electrode E2, by coupling the retaining clamp 14 accordingly with the circuit arrangement shown in FIG. 2 or in FIG. 3.

A retaining clamp arranged in a sealing rubber 50 can be segmented, so that for example the electrodes 13, 14 shown in FIG. 5 can be provided. Advantageously the segmentation takes place in such a way that the resulting electrode segments are arranged symmetrically to the vehicle longitudinal axis. Both segments then are accordingly coupled each with the circuit arrangement shown in FIG. 2 or in FIG. 3, preferably by means of a multiplexer.

It is particularly advantageous to arrange the circuit arrangements shown in FIG. 2 or in FIG. 3 directly at the electrodes E2 (thus on or in the sealing rubber), so that a signal processing can take place just off of the electrodes E2. Additional isolated or shielded lines for connecting the electrodes E2 with the circuit arrangement thus are not necessary.

By using the retaining clamps present in the sealing rubber 50 as electrode(s) E2, the installation of additional electrodes can be dispensed with, so that a particularly space saving antitrap protection is practicable.

Besides the disposition shown in FIG. 4 of an electrode E2, in which a retaining clamp provided as a standard feature in the sealing rubber 50 is used as an electrode, an electrode E2 can be arranged also in another way at accordingly suitable places of the vehicle body 40.

For example a conductive layer can be arranged on the body, which is separated from the body by an insulating layer. For example as conductive layer a conductive varnish can be used and as insulating layer a non-conductive varnish. The use of conductive varnishes as electrode(s) E2 makes possible a particularly flexible use of the antitrap protection system according to the invention. A particular advantage of conductive varnishes consists in the fact that they maintain their geometry particularly well, as the performance of the antitrap protection system can be influenced by a changing electrode geometry.

The use of wires arranged on the body (which must be isolated against the body) is also possible. In doing so it should be ensured that the geometry of the wires or the disposition of the wires cannot change unwantedly, for example by mechanical action on the wires.

FIG. 5 shows an electrically movable top of a convertible vehicle with an antitrap protection system according to the invention in the top view and in the side view.

The top comprises a first movable top component 21 and another movable top component 22, the second movable top component 22 being for example a soft-top and the first movable top component 21 a protective flap for the stowage space, the movable top component 22 being stowed in the open state of the convertible top system.

On the fixed components of the convertible top system the electrodes 11, 12, 13 and 14 are arranged. The electrode arrangement can take place as described above. Other arrangements are also possible. The electrodes 13, 14 are arranged symmetrically to the vehicle longitudinal axis on the body component group connecting the A-pillars. The electrodes 11, 12 are arranged at or in the vehicle body 40 near the lower conclusion of the movable top component 21. The top components 21, 22 each take over the function of an electrode SE, as described in FIG. 1 to FIG. 3. On closing the convertible top system, the top component 22 and thus the electrode SE formed by the top component 22 approaches the two electrodes 13, 14 (in which the electrodes 13, 14 correspond to the electrode EE or E2 from FIG. 2 or FIG. 3) and the vehicle body 40 (in which the vehicle body corresponds to the electrode EE or E1 from FIG. 1 or FIG. 3).

The electrodes 13, 14 (=E2 from FIG. 3), the electrode formed by the vehicle body E1 and the electrode SE formed by the top component 22 are each accordingly connected with the circuit arrangement according to FIG. 3.

The exits of the circuit arrangement are fed to an evaluating device 20. The evaluating device 20 presents an exit OUT, which can be connected for its part with an adjusting device 30 for the drive of the top component 22. The evaluating device 20 presents two entries POS1 and POS2 with the current position of the two top components 21 and 22 during the locking process.

The electrodes 11, 12 as well as the top component 21 are also accordingly connected with the circuit arrangement according to FIG. 3. The entries of the evaluating device, to which the corresponding exits of the circuit arrangement for the electrodes 11 to 14 are connected, are indicated with the reference signs E1 to E4.

The exits, to which the electrodes SE (or 21 and 22) are connected, are indicated with the reference signs LC1 and LC2. The vehicle body, which constitutes the electrode E1, is coupled with mass over the entry GND.

Alternatively the evaluating device 20 can also present the corresponding circuit arrangements, so that the corresponding electrodes can be connected directly on the respective entries E1 to E4, LC1 and LC2.

The evaluating device 20 can, as indicated in FIG. 5, consist of an integrated component.

During the locking process of the convertible top system the electric field between the single electrode devices varies. For example the electric field between the electrode 22 formed by the top component (=SE) and the electrode 13 (=E2) varies. A the same time also the electric field between the electrode 22 formed by the top component (=SE) and the electrode 40 formed by the body (=E1) varies. These variations have a determined characteristic for the top process. These variations conditioned by the adjusting process can be compensated if necessary as described above.

An intrusion into the range of motion of the top component 22 then leads to a change of the electric field of the single electrode device, which do not fit the characteristic of the top process and/or which no longer can be compensated by a compensation. This performance can be interpreted then as intrusion into the range of motion. How the detection or the survey takes place exactly, has been described above for the FIGS. 1 to 3.

When recognizing an intrusion, the evaluating device 20 at its exit OUT of the adjusting device 30 makes a signal available, by which the break-off of the top process is signaled.

In the closed or in the open state of the convertible top system the total antitrap protection system can be deactivated. Malfunctions in the open or closed state of the convertible top system thus can be prevented efficiently, since for the rest also in the open or in the closed state an electric field is in contact with the respective electrode devices. Alternatively the method according to the invention can be used however specifically also as vandalism or intrusion protection. In the closed state of a top for example an approach to the top can be recognized. In the open state a grabbing from the outside into the interior of the car can be recognized. In either instance for example an alarm can be triggered. Preferably the vandalism or intrusion protection is activatable or deactivatable.

The antitrap protection system according to the invention can be employed also in other areas, like for example in electrically closable doors (elevators, doors in trains) or other systems where there is the danger of entrapment of e.g. human limbs.

1. An antitrap protection system for a moving system, the antitrap system comprising
at least one capacitor system, comprising
a first electrode device with a first and a second electrode;
a second electrode device with a third and a fourth electrode;
a LC oscillating circuit formed by the first electrode device and an inductance;
a signal generator for charging the first electrode device and the second electrode device with an adjustable frequency and amplitude; and
a capacitor for coupling the signal generator with the first electrode device and the second electrode device;
whereby
the signal provided by the signal generator and the signal present at the LC oscillating circuit form a first indication for an approach of an object to the electric field of the first electrode device, and
the signal provided by the signal generator and the signal tapped at the fourth electrode form a second indication for an approach of an object to the electric field of the second electrode device.

2. The antitrap protection system according to claim 1, whereby the third electrode of the second electrode device is formed by the first electrode of the first electrode device.

3. The antitrap protection system according to claim 1, further comprising a XOR gate for connecting the signal provided by the signal generator with the signal present at the LC oscillating circuit, whereby the signal provided by the signal generator and the signal present at the LC oscillating circuit by means of a comparator are fed to the XOR gate for producing a square signal, and whereby the steady component of the signal present at the XOR gate exit, which is smaller than a predetermined value, constitutes the first indication.

4. The antitrap protection system according to claim 3, whereby the signal present at the XOR gate exit is fed to a low pass filter and whereby the steady component of the signal emitted by the low pass filter, which is smaller than a predetermined value, constitutes the first indication.

5. The antitrap protection system according to claim 1, further having an amplifier, whereby the signal tapped at the fourth electrode is fed to the amplifier, whereby the signal provided by the signal generator by means of a first phase shifter and a switch is used for the detection of the signal present at the exit of the amplifier and whereby the steady component of the detected signal constitutes the second indication.

6. The antitrap protection system according to claim 5, whereby the amplifier is a transimpedance amplifier, preferably with bandpass feature.

7. The antitrap protection system according to claim 5, whereby the detected signal is fed to a low pass filter and whereby the steady component of the signal present at the exit of the low pass filter, which is smaller than a predetermined value, constitutes the second indication.

8. The antitrap protection system according to claim 1, whereby the signal generator is adjustable as for the generator frequency and/or the generator voltage, whereby the antitrap protection system can be coupled with an evaluating device and whereby the inductance is formed as a passive inductance or active inductance, preferably as a Gyrator.

9. The antitrap protection system according to claim 1, whereby this is formed in such a way that an intrusion into the range of motion of the moving system causes a variation of the first indication or the second indication.

10. The antitrap protection system according to claim 1, whereby a switch for coupling the signal generator with the first or third electrode is provided.

11. The antitrap protection system according to claim 1, whereby the quality factor of the LC oscillating circuit is adjustable by a current input proportional to the oscillation circuit voltage.

12. The antitrap protection system according to claim 1, whereby the signal provided by the signal generator by means of a countercurrent compensation arrangement is coupled with the signal tapped at the fourth electrode, whereby the countercurrent compensation arrangement comprises an inverting amplifier and a second phase shifter coupled with it.

13. A vehicle, with an electrically actuated convertible top system and with an antitrap protection system according to claim 1, whereby the convertible top system comprises at least one moved component and whereby the antitrap protection system is formed in such a way that in the event of intrusion into the range of motion of the convertible top system the closing process or the opening process of the convertible top system can be interrupted, stopped or reversed.

14. The vehicle according to claim 13, whereby the first or third electrode of the antitrap protection system is formed by the moved component of the convertible top system, whereby the second electrode is formed by the vehicle body or chassis and whereby the fourth electrode is formed by at least one electrode arranged isolated on the vehicle in the outer area of the range of motion of the convertible top system.

15. The vehicle according to claim 14, whereby the at least one electrode arranged isolated on the vehicle is arranged symmetrically to the longitudinal axis of the vehicle.

16. The vehicle according to one claim 13, whereby the antitrap protection system in the closed and/or in the open state of the convertible top system is deactivatable.

17. The vehicle according to one claim 13, whereby the convertible top system is connected to the vehicle body by means of a preferably switchable insulator.

18. The vehicle according to claim 13, whereby the convertible top system, preferably using a shield electrode of the vehicle body, can be electrically decoupled.

19. An antitrap protection system for a moving system, the antitrap comprising
a LC oscillating circuit, which comprises an electrode device with a first electrode and a second electrode and an inductance, whereby the electrode device is part of a capacitor system;
a signal generator for charging the LC oscillating circuit with an adjustable frequency and amplitude; and
a capacitor for coupling the signal generator with the LC oscillating circuit;
whereby the signal provided by the signal generator and the signal present at the LC oscillating circuit are indicative for an approach of an object to the electric field of the electrode device.

20. The antitrap protection system according to claim 19, further comprising a XOR gate for connecting the signal provided by the signal generator with the signal present at the LC oscillating circuit, whereby the signal provided by the signal generator and the signal present at the LC oscillating circuit are fed to the XOR gate by at least one comparator for producing a square signal and whereby the signal present at the XOR gate exit is indicative for an approach of an object to the electric field of the electrode device.

21. The antitrap protection system according to claim 20, whereby the steady component, preferably a steady component which is smaller than a predetermined value, of the signal present at the XOR gate exit is indicative for an approach of an object to the electric field of the electrode device.

22. The antitrap protection system according to claim 20, whereby the signal present at the XOR gate exit is fed to a low pass filter and whereby the steady component of the signal emitted by the low pass, preferably a steady component which is smaller than a predetermined value, is indicative for an intrusion into the electric field of the electrode device.

23. The antitrap protection system according to one claim 19, whereby a change of the capacity of the electrode device causes a phase shift between the signal provided by the signal generator and the signal present at the LC oscillating circuit, which is indicative for an approach of an object to the electric field of the electrode device.

24. The antitrap protection system according to claim 19, whereby the signal generator is adjustable as for the generator frequency and/or the generator voltage and whereby the inductance is formed as a passive inductance or active inductance, preferably as a Gyrator.

25. The antitrap protection system according to claim 19, whereby the adjustable frequency is in the range of the parallel resonance frequency of the LC oscillating circuit and whereby a change of the electric field or the capacity of the electrode device caused by a motion of the moving system can be compensated.

26. The antitrap protection system according to claim 25, whereby a compensation takes place by readjusting the signal generator on the resonance frequency of the LC oscillating circuit, and whereby the antitrap protection system can be coupled with an evaluating device.

27. The antitrap protection system according to claim 19, whereby the quality factor of the LC oscillating circuit is adjustable by a current input proportional to the oscillation circuit voltage.

28. A moving system with at least one moving component, at least one further component and an antitrap protection system according to claim 19, whereby the moving component is displaceable in an adjusting range relatively to the further component, whereby the moving component constitutes the first electrode of the electrode device of the antitrap protection system and whereby the further component constitutes the second electrode of the electrode device of the antitrap protection system.

29. Moving system according to claim 28, whereby the moving component comprises a convertible top system for vehicles, whereby the further component comprises a vehicle body or a chassis and whereby the moving component is connected to the further component by a, preferably switchable, insulator.

30. Moving system according to claim 28, whereby the moving component, preferably using a shield electrode, can be electrically decoupled from the further component.

31. An antitrap protection system for a moving system, having
an electrode device with at least one first electrode and at least one second electrode, whereby the electrode device is part of a capacitor system; and
a signal generator for charging the capacitor system with an adjustable frequency and amplitude, whereby the signal generator is coupled with the first electrode of the electrode device;
whereby the signal provided by the signal generator and the signal tapped at the second electrode of the electrode device are indicative for an approach of an object to the electric field of the electrode device.

32. The antitrap protection system according to claim 31, further comprising an amplifier, whereby the signal used at the second electrode of the electrode device is fed to the amplifier, whereby the signal provided by the signal generator by means of a first phase shifter and a switch is used for detection of the signal present at the exit of the amplifier and whereby the detected signal is indicative for an approach of an object to the electric field of the electrode device.

33. The antitrap protection system according to claim 32, whereby the amplifier is a transimpedance amplifier, preferably with bandpass feature.

34. The antitrap protection system according to claim 32, whereby the detected signal is fed to a low pass filter and whereby the steady component of the signal present at the exit of the low pass filter is indicative for an approach of an object to the electric field of the electrode device.

35. The antitrap protection system according to claim 31, whereby the signal generator is adjustable as for the generator frequency and/or the generator voltage.

36. The antitrap protection system according to claim 31, whereby a variation of the electric field of the electrode device caused by a motion of the moving system can be compensated.

37. The antitrap protection system according to claim 36, whereby a compensation takes place by readjusting the signal generator voltage and whereby the antitrap protection system can be coupled with an evaluating device.

38. The antitrap protection system according to claim 31, whereby the signal provided by the signal generator by means of a countercurrent compensation arrangement is coupled with the signal tapped at the second electrode, whereby the countercurrent compensation arrangement comprises an inverting amplifier and a second phase shifter coupled with it.

39. A moving system with at least one moving component, at least one further component and an antitrap protection system according to claim 31, whereby the moving component is displaceable in an adjusting range relatively to the further component, whereby the moving component constitutes the first electrode of the electrode device of the antitrap protection system and whereby the further component constitutes the second electrode of the antitrap protection system.

40. The moving system according to claim 39, whereby the moving component comprises a convertible top system for vehicles and whereby the further component comprises at least one electrode arranged isolated on the vehicle body.

41. The moving system according to claim 40, whereby the electrode arranged isolated on the vehicle body is a stripe-shaped electrode or an electrode formed as conductive varnish or an electrically conductive clamp for sealing rubber.

42. The moving system according to claim 40, whereby the electrode arranged on the vehicle body is segmented, and whereby the electrode segments are preferably arranged symmetrically to the vehicle longitudinal axis.
